(19) United States
(12) Patent Application Publication
(10) Pub. No.: US 2026/0195371 A1
(43) Pub. Date: Jul. 9, 2026

(54) IMAGE RETRIEVAL DEVICE, IMAGE RETRIEVAL METHOD, AND STORAGE MEDIUM

(71) Applicant: NEC Corporation, Tokyo (JP)

(72) Inventors: Naoya SOGI, Tokyo (JP); Makoto Terao, Tokyo (JP); Takashi Shibata, Tokyo (JP); Taku Fujitomi, Tokyo (JP)

(73) Assignee: NEC Corporation, Tokyo (JP)

(21) Appl. No.: 19/424,535

(22) Filed: Dec. 18, 2025

(30) Foreign Application Priority Data
Jan. 6, 2025 (JP) 2025-001687

(51) Int. Cl. G06F 16/53

(52) U.S. Cl. CPC G06F 16/53

(57) ABSTRACT

In an image retrieval device, a retrieval query acquisition means acquires a retrieval query as information indicating a retrieval image. A diversity request value acquisition means acquires a diversity request value indicating degree to which diversity of external information associated with retrieval target images is to be increased or decreased. An optimization means selects any image from the retrieval target images in such a way that the degree of diversity calculated based on the external information meets the diversity request value.

### INCORPORATION BY REFERENCE

This application is based upon and claims the benefit of priority from Japanese patent application No. 2025-001687, filed on Jan. 6, 2025, the disclosure of which is incorporated herein in its entirety by reference.

### TECHNICAL FIELD

The present disclosure relates to an image retrieval technique.

### BACKGROUND ART

There is a known image retrieval technique for a user to retrieve desired image data from a large amount of image data. For example, Patent Document 1 describes a proposed information retrieval device that efficiently retrieves any information, such as image data, with diversity retained.

Patent Document 1: Japanese Patent 2004-259061 A

### SUMMARY

However, according to the method in Patent Document 1, image retrieval is difficult to perform with diversity controlled in order to obtain a localized retrieval result or in order to obtain a diversified retrieval result.

One object of the present disclosure is to provide an image retrieval device enabling image retrieval with diversity controlled.

According to an example aspect of the present invention, there is provided an image retrieval device, including:
at least one memory configured to store instructions; and
at least one processor configured to execute the instructions to:
acquire a retrieval query as information indicating a retrieval image;
acquire a diversity request value indicating degree to which diversity of external information associated with retrieval target images is to be increased or decreased; and
select an image from the retrieval target images in such a way that a degree of diversity calculated based on the external information meets the diversity request value.

According to another example aspect of the present invention, there is provided an image retrieval method including:
acquiring a retrieval query as information indicating a retrieval image;
acquiring a diversity request value indicating degree to which diversity of external information associated with retrieval target images is to be increased or decreased; and
selecting an image from the retrieval target images in such a way that a degree of diversity calculated based on the external information meets the diversity request value.

According to a further example aspect of the present invention, there is provided a recording medium recording a program for causing a computer to execute processing including:
acquiring a retrieval query as information indicating a retrieval image;
acquiring a diversity request value indicating degree to which diversity of external information associated with retrieval target images is to be increased or decreased; and
selecting an image from the retrieval target images in such a way that a degree of diversity calculated based on the external information meets the diversity request value.

### EFFECT

According to the present disclosure, image retrieval can be performed with diversity controlled.

### BRIEF DESCRIPTION OF THE DRAWINGS

FIG. 1 illustrates an image retrieval device according to the present disclosure;

FIGS. 2A and 2B illustrate examples of image retrieval with diversity of external information taken into account;

FIG. 3 is a block diagram illustrating a hardware configuration of the image retrieval device according to the present disclosure;

FIG. 4 is a block diagram illustrating a functional configuration of the image retrieval device according to the present disclosure;

FIG. 5 illustrates examples of the external information and examples of conversion thereof;

FIG. 6 is an explanatory diagram for processing that a diversity adjustment unit performs;

FIG. 7 is a flowchart of processing that the image retrieval device according to the present disclosure performs;

FIGS. 8A to 8C illustrate examples of processing in a case where a plurality of types of external information is used;

FIG. 9 illustrates exemplary image retrieval results;

FIGS. 10A and 10B illustrate examples of processing for presenting a plurality of image retrieval results;

FIG. 11 is a block diagram illustrating a functional configuration of another image retrieval device according to the present disclosure; and

FIG. 12 is a flowchart of processing that the another image retrieval device according to the present disclosure performs.

### EXAMPLE EMBODIMENTS

Preferred example embodiments of the present disclosure will be described below with reference to the drawings.

### First Example Embodiment

### Overview

An image retrieval device according to the present example embodiment retrieves images based on a user's intention from a large number of images stored in an image database (DB). In particular, as a feature, the image retrieval device according to the present example embodiment is capable of adjusting an image retrieval result while taking account of the diversity of external information associated with the images. Examples of the external information include the capturing date and time, the capturing location, and the capturer for each image. The user can designate the image retrieval device to perform image retrieval with an increase in the diversity of the external information or image retrieval with a decrease in the diversity of the external information.

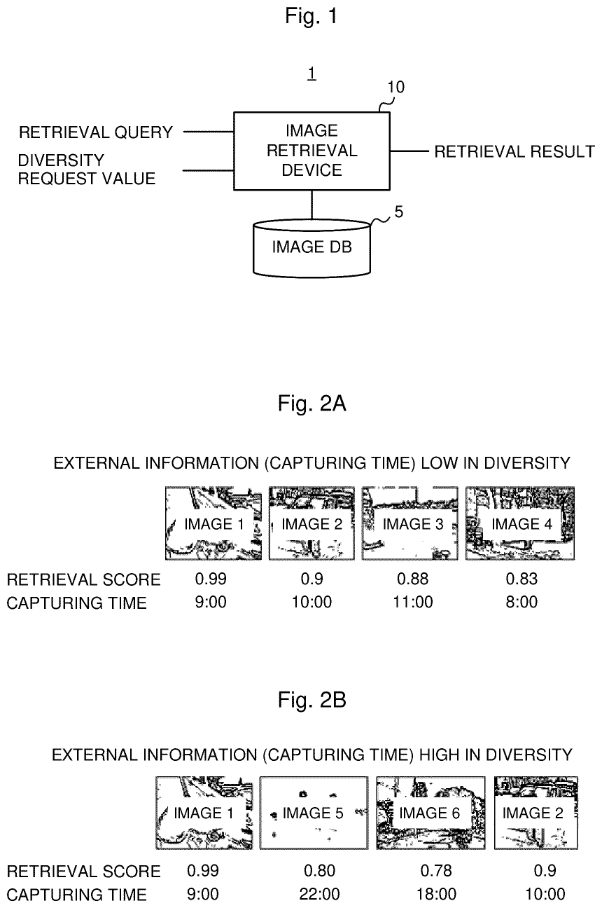

FIG. 1 illustrates the image retrieval device according to the present example embodiment. An image retrieval device 10 performs image retrieval on an image DB 5, based on a retrieval query and a diversity request value as inputs. The image DB 5 stores a large number of images in advance. The images stored in the image DB 5 are each an exemplary “retrieval target image”. The diversity request value indicates the degree to which the diversity of the external information should be increased or decreased. The external information is stored in association with the images in the image DB 5.

FIGS. 2A and 2B illustrate examples of image retrieval with the diversity of the external information taken into account. Referring to FIGS. 2A and 2B, as the external information, the capturing time is used. FIG. 2A illustrates a result of image retrieval with a decrease in the diversity of the external information (namely, the capturing time). As illustrated, the image retrieval device 10 outputs images having high retrieval scores and being based on a specific time period (images captured in the morning). FIG. 2B illustrates a result of image retrieval with an increase in the diversity of the external information (namely, the capturing time). As illustrated, the image retrieval device 10 outputs images having high retrieval scores and being based on capturing at various times.

Instead of the above, in a case where the capturing location is used as the external information, image retrieval with a decrease in diversity causes output of images captured at locations in a limited range (in a narrow range), and image retrieval with an increase in diversity causes output of images captured at various locations (in a wide range). In a case where the capturer is used as the external information, image retrieval with a decrease in diversity causes output of images captured by a particular person, and image retrieval with an increase in diversity causes output of images captured by various persons.

As above, the image retrieval device according to the present example embodiment can diversify or localize an image retrieval result with the external information taken into account.

Note that, according to a conventional image retrieval method, specifying the range of the external information enables the range of image retrieval to be widened or narrowed. However, according to such a conventional method, for example, even in a case where a long period of time (e.g., from 7:00 to 23:00) is specified as the range of the capturing time, the images in a particular period of time (e.g., from 7:00 to 12:00) may be output, and thus diversification is not necessarily achieved. In addition, according to the conventional method, for example, in a case where a short period of time (e.g., from 7:00 to 9:00) is specified as the range of the capturing time, the images in the range of an error (e.g., at 9:10) are excluded from the retrieval targets, and thus images based on a user's intention may be missed. In contrast to this, the image retrieval device according to the present example embodiment diversifies or localizes an image retrieval result, based on the diversity request value, and thus the diversity can be preferably controlled without specifying the range of the external information.

### Hardware Configuration

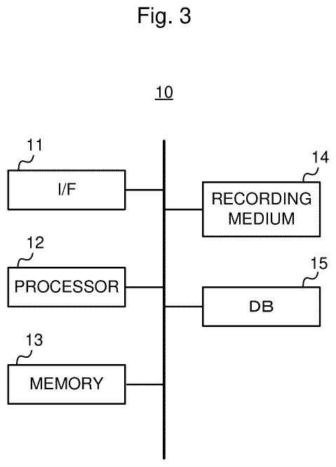

FIG. 3 is a block diagram illustrating a hardware configuration of the image retrieval device 10 according to the first example embodiment. As illustrated, the image retrieval device 10 includes an interface (I/F) 11, a processor 12, a memory 13, a recording medium 14, and a database (DB) 15.

The I/F 11 inputs/outputs data to/from an external device. Specifically, a retrieval query and a diversity request value are input to the image retrieval device 10 through the I/F 11. In addition, the data stored in the image DB 5 is input to the image retrieval device 10 through the I/F 11.

The processor 12 corresponds to a computer, such as a central processing unit (CPU), and executes a previously prepared program to control the entire image retrieval device 10. Note that the processor 12 may be a graphics processing unit (GPU), a digital signal processor (DSP), a micro processing unit (MPU), a floating point unit (FPU), a physics processing unit (PPU), a tensor processing unit (TPU), a quantum processor, a microcontroller, or any combination thereof. The processor 12 performs image retrieval processing, which will be described later.

The memory 13 includes a read only memory (ROM), a random access memory (RAM), and the like. The memory 13 is also used as a working memory while the processor 12 is performing various types of processing.

The recording medium 14 corresponds to a non-volatile and non-transitory recording medium, such as a disk-shaped recording medium or a semiconductor memory, and is detachably attached to the image retrieval device 10. The recording medium 14 has various types of programs, which the processor 12 executes, recorded thereon. For the image retrieval device 10 to perform various types of processing, a program recorded on the recording medium 14 is loaded into the memory 13 and then the processor 12 executes the program. The DB 15 stores an image retrieval result.

Note that, in addition to the above, the image retrieval device 10 may include a display device, such as a liquid crystal display, and an input device, such as a keyboard or a mouse. Such a display device and an input device are used, for example, by an administrator for the image retrieval device 10 for necessary management.

### Functional Configuration

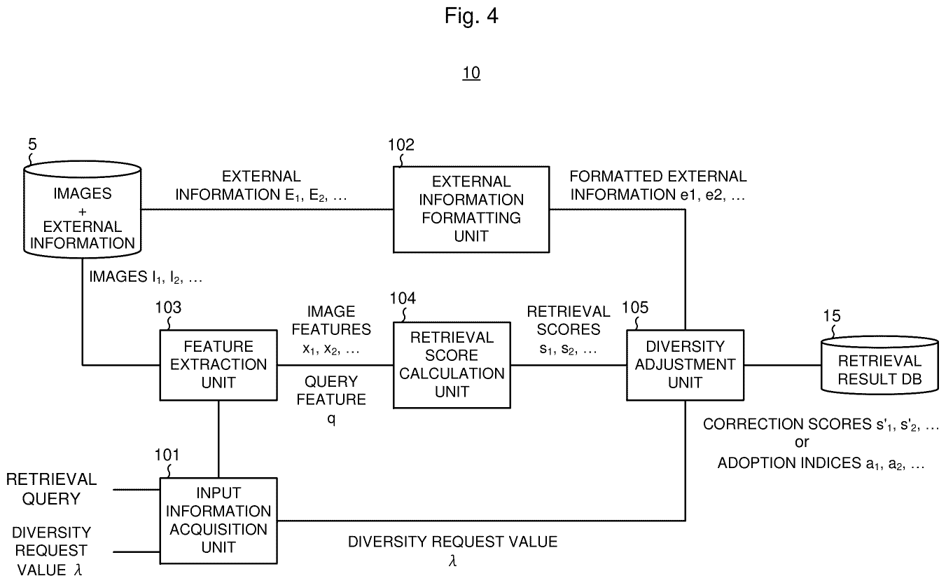

FIG. 4 is a block diagram illustrating a functional configuration of the image retrieval device 10 according to the first example embodiment. The image retrieval device 10 functionally includes an input information acquisition unit 101, an external information formatting unit 102, a feature extraction unit 103, a retrieval score calculation unit 104, and a diversity adjustment unit 105.

The input information acquisition unit 101 acquires a retrieval query and a diversity request value from a user. The input information acquisition unit 101 outputs the retrieval query to the feature extraction unit 103 and outputs the diversity request value to the diversity adjustment unit 105. Note that the retrieval query corresponds to information indicating a retrieval image. The user can specify the retrieval image using a free word or an image. The diversity request value indicates the degree to which the diversity should be increased or decreased. The user specifies “−1” for a decrease in diversity and specifies “1” for an increase in diversity. Note that the user may specify the diversity request value in a range of −1 to 1.

The external information formatting unit 102 acquires pieces of external information (E₁, E₂, . . . ) on images from the image DB 5. Note that E₁ represents the external information of the first image and E₂ represents the external information of the second image. Then, the external information formatting unit 102 converts external information of each image into a numerical value or numerical vector. Hereinafter, such external information converted into a numerical value or numerical vector is also referred to “formatted external information”. The external information formatting unit 102 outputs the formatted external information (e₁, e₂, . . . ) of each image to the diversity adjustment unit 105.

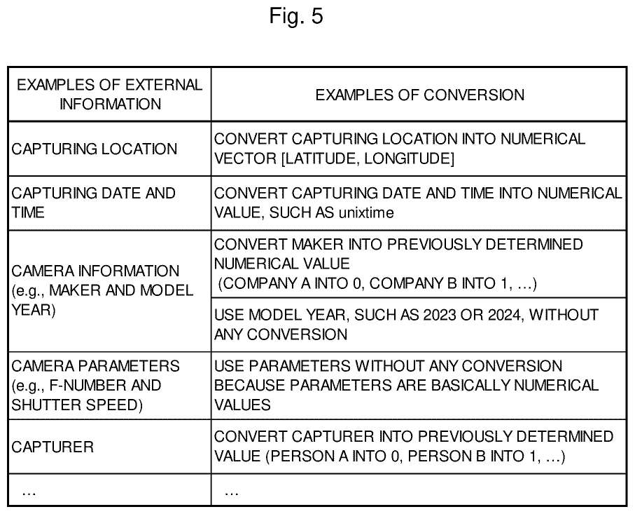

FIG. 5 illustrates examples of the external information and examples of conversion of thereof. As illustrated, examples of the external information include the capturing location, the capturing date and time, the camera information, the camera parameters, and the capturer. The external information formatting unit 102 converts, into formatted external information, a type of external information specified in advance by the user from a plurality of types of external information. Note that the external information is not limited to the above examples and thus may be any information derived from image data, such as temperature or weather, the tag added by a person, acoustic data, a SAR image, a distance image, or a LiDAR image.

The feature extraction unit 103 extracts features (x₁, x₂, . . . ) from images (I₁, I₂, . . . ) stored in the image DB 5. Note that I₁ represents the first image and I₂ represents the second image. In addition, the feature extraction unit 103 extracts a feature (q) from the retrieval query. The feature extraction unit 103 can use, for example, a convolutional neural network (CNN) as an image feature extraction method. In addition, the feature extraction unit 103 can use, for example, BERT or Word2Vec as a text feature extraction method. The feature extraction unit 103 outputs the features of each image (x₁, x₂, . . . ) and the feature of the retrieval query (q) to the retrieval score calculation unit 104.

The retrieval score calculation unit 104 calculates retrieval scores (s₁, s₂, . . . ) of each image based on the features of the images (x₁, x₂, . . . ) and the feature of the retrieval query (q). Such a retrieval score corresponds to a score indicating the relevance between the image and the retrieval query, and the relevance between the associated image and the retrieval query increases as the value of the retrieval score increases. For example, the retrieval score calculation unit 104 calculates similarity between the feature of each image and the feature of the retrieval query, and sets a higher retrieval score to image with higher in similarity. Note that, as an indicator for similarity, Euclidean distance or cosine similarity is used. The retrieval score calculation unit 104 outputs the retrieval scores (s₁, s₂, . . . ) of each image to the diversity adjustment unit 105.

The diversity adjustment unit 105 determines a retrieval result (namely, a combination of images to be output) based on the formatted external information of each image (e₁, e₂, . . . ), the retrieval scores of each image (s₁, s₂, . . . ), and the diversity request value (λ). The diversity adjustment unit 105 can determine the retrieval result by considering both the retrieval scores and the level of diversity (or the lack thereof), using known optimization methods. Then, the diversity adjustment unit 105 outputs the retrieval result to the DB 15. In addition, the diversity adjustment unit 105 outputs the retrieval result to a user's terminal device.

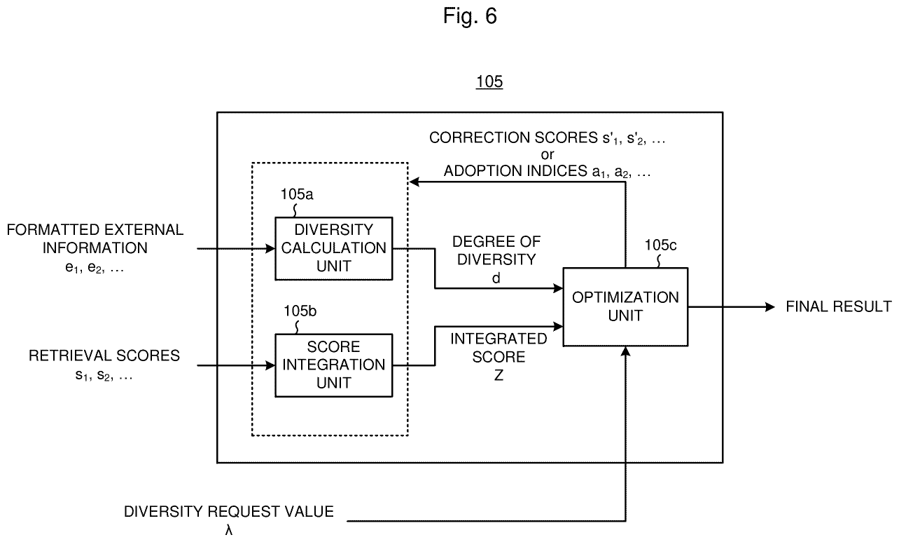

FIG. 6 is an explanatory diagram for processing that the diversity adjustment unit 105 performs. The diversity adjustment unit 105 includes a diversity calculation unit 105a, a score integration unit 105b, and an optimization unit 105c.

The formatted external information (e₁, e₂, . . . ) of each image is input to the diversity calculation unit 105a. In addition, correction scores (s′₁, s′₂, . . . ) or adoption indices (a₁, a₂, . . . ) of each image are input from the optimization unit 105c to the diversity calculation unit 105a.

The retrieval scores (s₁, s₂, . . . ) of each image is input to the score integration unit 105b. In addition, the correction scores (s′₁, s′₂, . . . ) or the adoption indices (a₁, a₂, . . . ) of each image are input from the optimization unit 105c to the score integration unit 105b.

The correction score is a value calculated by performing a predetermined arithmetic operation on the retrieval score of each image and the correction value. The adoption indices each correspond to an index indicating whether each image is to be adopted as a retrieval result and are each expressed using two values of 0 (adoption allowed) and 1 (adoption not allowed). Note that, in the first processing, for such a correction value or an adoption index, for example, a random value or a value initialized in accordance with a previously determined rule is used.

In a case where the correction scores are input, the diversity calculation unit 105a selects a predetermined number of images in descending order of the correction scores. On the other hand, in a case where the adoption indices are input, the diversity calculation unit 105a selects any image the adoption index of which is 0. Then, based on the pieces of formatted external information on the selected images (hereinafter, also referred to as pieces of “selected formatted external information”), the diversity calculation unit 105a calculates the degree of diversity (d).

For example, in a case where the pieces of formatted external information are each a numerical value, the diversity calculation unit 105a may calculate the variance of the pieces of selected formatted external information and take the calculated variance as the degree of diversity. Regarding the pieces of selected formatted external information, the diversity calculation unit 105a may calculate difference and similarity between every pair and take the largest difference (hereinafter, also referred to as “maximum difference”), the determinant of a matrix in which similarities are arrayed, or the Vendi score as the degree of diversity. For example, the diversity calculation unit 105a can calculate difference due to Euclidean distance and calculate similarity due to inner product. Regarding the pieces of selected formatted external information, the diversity calculation unit 105a may take the entropy estimated using all the pieces of external information as the degree of diversity. For example, the diversity calculation unit 105a can calculate the entropy using a density function estimated due to kernel density estimation. The diversity calculation unit 105a may take the earth mover's distance between all the pieces of formatted external information and the pieces of selected formatted external information as the degree of diversity.

Note that, in a case where the pieces of formatted external information are each a numerical vector, the diversity calculation unit 105a may calculate the trace or Frobenius norm of a covariance matrix of the pieces of selected formatted external information and take a calculation result as the degree of diversity. The diversity calculation unit 105a may take, as the degree of diversity, the entropy estimated using the density function of the pieces of selected formatted external information obtained by a density estimation method, such as the Vendi Score, the determinant of a matrix in which similarities are arrayed, or the kernel density estimation. The diversity calculation unit 105a may take the earth mover's distance between all the pieces of formatted external information and the pieces of selected formatted external information as the degree of diversity.

The diversity calculation unit 105a outputs the degree of diversity (d) to the optimization unit 105c.

In a case where the correction scores are input, the score integration unit 105b selects a predetermined number of images in descending order of the correction scores. On the other hand, in a case where the adoption indices are input, the score integration unit 105b selects any image the adoption index of which is 0. Then, the score integration unit 105b calculates an integrated score (z), based on the retrieval scores of the selected images.

For example, the score integration unit 105b may take the total or average of the retrieval scores of the selected images as the integrated score. The score integration unit 105b may take the total or average of the correction scores of the selected images as the integrated score. The score integration unit 105b outputs the integrated score (z) to the optimization unit 105c.

The diversity request value (λ), the degree of diversity (d), and the integrated score (z) are input to the optimization unit 105c. The optimization unit 105c updates the correction value or adoption index of each image using an existing optimization method, such as a determinantal point process or a gradient descent method, in such a way that the following Expression (1) is maximized.

$$z + λ d \qquad ( 1 )$$

In other words, the optimization unit 105c updates the correction value or adoption index of each image in such a way that the integrated score increases and the degree of diversity (d) decreases in a case where the diversity request value is low (namely, “−1”) or updates the correction value or adoption index of each image in such a way that the integrated score increases and the degree of diversity (d) increases in a case where the diversity request value is high (namely, “1”).

Note that, instead of the above, for example, the optimization unit 105c may update the correction value or adoption index of each image using a multi-objective optimization method.

In a case where the correction values are updated, the optimization unit 105c recalculates the correction score of each image and then outputs the recalculated correction score of each image to the diversity calculation unit 105a and the score integration unit 105b. On the other hand, in a case where the adoption indices are updated, the optimization unit 105c outputs the updated adoption indices to the diversity calculation unit 105a and the score integration unit 105b.

The diversity calculation unit 105a, the score integration unit 105b, and the optimization unit 105c perform the above-described processing repeatedly until a predetermined criterion is fulfilled, and the final correction score or adoption index of each image is taken as an optimum solution. The predetermined criterion may be, for example, a condition that the value of Expression (1) is equal to or more than a predetermined threshold TH1 or a condition that the number of times the above-described processing is repeated has reached a previously set maximum.

Based on the final correction score or adoption index of each image, the optimization unit 105c selects an image to be output as a retrieval result. Specifically, the optimization unit 105c selects any image the correction score of which is equal to or more than a predetermined threshold TH2 as the retrieval result. Alternatively, the optimization unit 105c selects any image the adoption index of which is 0 as the retrieval result. Then, the optimization unit 105c outputs the retrieval result to the DB 15. In addition, the optimization unit 105c outputs the retrieval result to the user's terminal device.

In the above-described configuration, the input information acquisition unit 101 corresponds to an exemplary retrieval query acquisition means and an exemplary diversity request value acquisition means, and the feature extraction unit 103, the retrieval score calculation unit 104, the external information formatting unit 102, and the diversity adjustment unit 105 correspond to an exemplary optimization means.

### Image Retrieval Processing

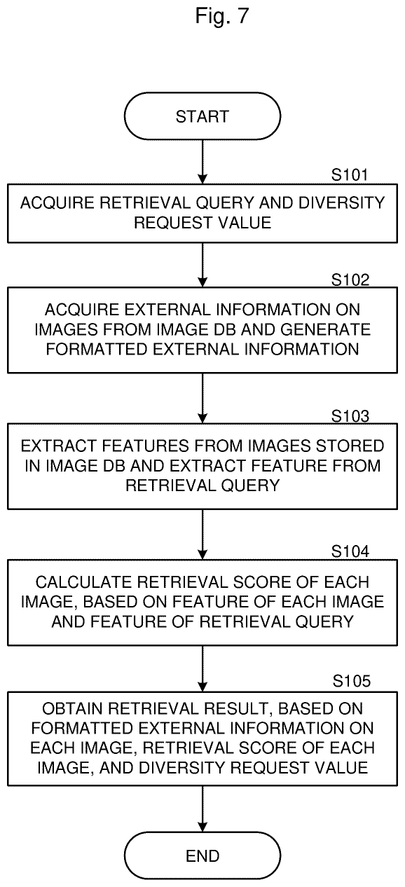

Next, such image retrieval processing as above will be described. FIG. 7 is a flowchart of image retrieval processing that the image retrieval device 10 performs. The processor 12 illustrated in FIG. 3 executes the previously prepared program to operate as each element illustrated in FIG. 4, so that the processing is achieved.

First, the input information acquisition unit 101 acquires a retrieval query and a diversity request value from a user (step S101). The input information acquisition unit 101 outputs the retrieval query to the feature extraction unit 103 and outputs the diversity request value to the diversity adjustment unit 105. Next, the external information formatting unit 102 acquires the pieces of external information on the images from the image DB 5 and converts the external information on each image into a numerical value or numerical vector to generate formatted external information (step S102). The external information formatting unit 102 outputs the formatted external information on each image to the diversity adjustment unit 105.

Next, the feature extraction unit 103 extracts a feature from each of the images stored in the image DB 5. In addition, the feature extraction unit 103 extracts a feature from the retrieval query (step S103). The feature extraction unit 103 outputs, to the retrieval score calculation unit 104, the feature of each image and the feature of the retrieval query. Next, based on the feature of each image and the feature of the retrieval query, the retrieval score calculation unit 104 calculates the retrieval score of each image (step S104). The retrieval score calculation unit 104 outputs the retrieval score of each image to the diversity adjustment unit 105.

Based on the formatted external information on each image, the retrieval score of each image, and the diversity request value, the diversity adjustment unit 105 obtains a retrieval result (step S105). Then, the diversity adjustment unit 105 outputs the retrieval result to the DB 15. In addition, the diversity adjustment unit 105 outputs the retrieval result to a user's terminal device. Then, the processing terminates.

### Modifications

Next, modifications of the first example embodiment will be described. The following modifications can be combined as appropriate for application to the first example embodiment.

### First Modification

In the above-described example embodiment, the diversity calculation unit 105a takes, for example, the variance of pieces of external information as the degree of diversity. Instead of this, the diversity calculation unit 105a may calculate, in a case where the capturing location is used as the external information, the degree of diversity using any of the following methods (1) to (3).

### (1) Take, as the Degree of Diversity, the Average Value or Maximum Value of Two-Spot Distances

The diversity calculation unit 105a selects images, based on the correction score or adoption index of each image, and then extracts combinations each involving two images from the selected images. Then, the diversity calculation unit 105a calculates the distance between the capturing spots of the two images for each combination and uses the resultant average value or maximum value as the degree of diversity. Thus, the degree of diversity increases as each distance increases and the degree of diversity decreases as each distance decreases.

Note that the distance between the capturing spots of two images (hereinafter, also referred to as a “two-spot distance”) may be a straight-line distance or a distance on a sphere.

The diversity calculation unit 105a may use, as the two-spot distance, the length of a road in travel between two spots or the time required for travel between two spots.

The diversity calculation unit 105a may use, as the two-spot distance, a travel distance or travel time with public transportation involved. In this case, the diversity calculation unit 105a may assign a weight in accordance with the type of transportation or may assign a weight in accordance with a transfer to another type of transportation or the number of transfers. For example, the diversity calculation unit 105a doubles the weight in a case where the transportation is a bus. For example, the diversity calculation unit 105a doubles the weight for a transfer from a train to a bus or increases the weight by 1.5 times for a transfer from a train A to a train B.

### (2) Take, as the Degree of Diversity, the Average Value of Minimum Travel Distances or Minimum Travel Times in Visiting to a Plurality of Spots

The diversity calculation unit 105a selects images, based on the correction score or adoption index of each image, and extracts combinations each involving a plurality of images from the selected images. Then, the diversity calculation unit 105a calculates the minimum travel distance or minimum travel time in visiting to the plurality of spots for each combination and uses the resultant average value as the degree of diversity.

### (3) Take, as the Degree of Diversity, the Minimum Travel Distance or Minimum Travel Time in Visiting to All Spots

The diversity calculation unit 105a selects images, based on the correction score or adoption index of each image. Then, the diversity calculation unit 105a calculates the minimum travel distance or minimum travel time in visiting to the capturing spots of all the selected images and uses a calculation result as the degree of diversity.

As above, the diversity calculation unit 105a can adjust the diversity in accordance with not only the distance on a map but also the actual environment, such as the travel distance, the travel time, or the complexity of travel.

### Second Modification

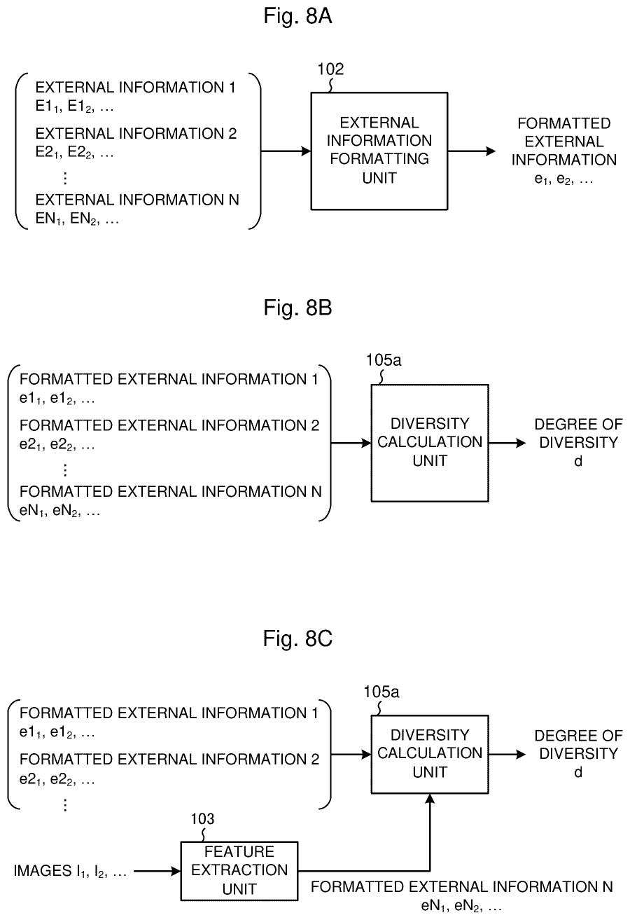

The image retrieval device 10 may use a plurality of types of external information. FIGS. 8A to 8C illustrate examples of processing in a case where a plurality of types of external information is used.

FIG. 8A illustrates exemplary processing that the external information formatting unit 102 performs. The external information formatting unit 102 receives a plurality of types of external information as an input and formats them into a single numerical vector by concatenating them. For example, in a case where the capturing location and the capturing time are used as the plurality of types of external information, the external information formatting unit 102 can format them into a numerical vector [latitude, longitude, unixtime]. Then, the external information formatting unit 102 outputs, to the diversity adjustment unit 105, the formatted numerical vector as formatted external information. Referring to FIG. 8A, the external information formatting unit 102 couples external information 1 (E1₁), external information 2 (E2₁), . . . , and external information N (EN₁) on the first image to output formatted external information (e₁) on the first image.

FIG. 8B illustrates exemplary processing that the diversity calculation unit 105a performs. In this example, the external information formatting unit 102 converts each type of external information into formatted external information without coupling the plurality of types of external information, and outputs the formatted external information to the diversity adjustment unit 105. In this case, the diversity calculation unit 105a calculates the degree of diversity for each type of formatted external information and integrates the calculated degrees of diversity, together. Then, the diversity calculation unit 105a outputs, to the optimization unit 105c, the degree of diversity resulting from the integration. Referring to FIG. 8B, the diversity calculation unit 105a calculates the degree of diversity for each image from pieces of formatted external information 1 (e1₁, e1₂, . . . ), the pieces of formatted external information 2 (e2₁, e2₂, . . . ), . . . , and the pieces of formatted external information N (eN₁, eN₂, . . . ), and integrates N number of degrees of diversity resulting from the calculation, together. For example, the diversity calculation unit 105a obtains the average of the N number of degrees of diversity for integration of degrees of diversity. In a case where the optimization unit 105c uses a determinantal point process, the diversity calculation unit 105a calculates N number of matrices each including similarities, which are calculated based on all the combinations of the images in the associated type of formatted external information, arrayed and integrates all the matrices together using a logarithm of a matrix and an exponential function, so that the determinant of a matrix resulting from the integration can be taken as the degree of diversity resulting from the integration.

The image retrieval device 10 may use image appearance information as external information. In this case, the feature extraction unit 103 outputs, to the diversity adjustment unit 105, an extracted image feature as one type of formatted external information. FIG. 8C illustrates exemplary processing in a case where image appearance is used as external information. Referring to FIG. 8C, the feature extraction unit 103 outputs, to the diversity calculation unit 105a, features extracted from the images (I₁, I₂, . . . ) as pieces of formatted external information N (eN₁, eN₂, . . . ). Then, the diversity calculation unit 105a calculates the degree of diversity from each type of formatted external information of each image and then integrates N number of degrees of diversity resulting from the calculation, together. Note that the feature extraction unit 103 may output, to the external information formatting unit 102, the features extracted from each image as external information. In this case, the external information formatting unit 102 couples a plurality of types of external information including the features of the image to generate formatted external information and outputs the formatted external information to the diversity adjustment unit 105. As above, image retrieval can be performed with adjustment of the degree of diversity of the image appearance together with the other types of external information, such as the capturing time.

### Third Modification

The image retrieval device 10 may present a plurality of image retrieval results.

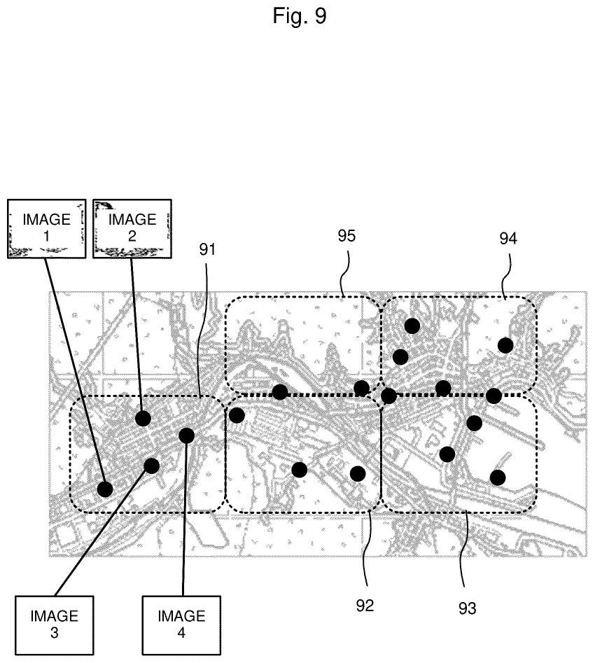

FIG. 9 illustrates exemplary image retrieval results. Note that filled circles in the drawing each indicate the capturing location of a retrieval target image. Referring to FIG. 9, the image retrieval device 10 performs image retrieval with a decrease in the diversity of the capturing location and outputs images 1 to 4 captured in an area 91 as an image retrieval result. However, images captured in the other areas 92 to 95 may be based on a user's intention. Thus, the image retrieval device 10 makes a switch between a plurality of image retrieval results in such a way that the images captured in the other areas can be also presented.

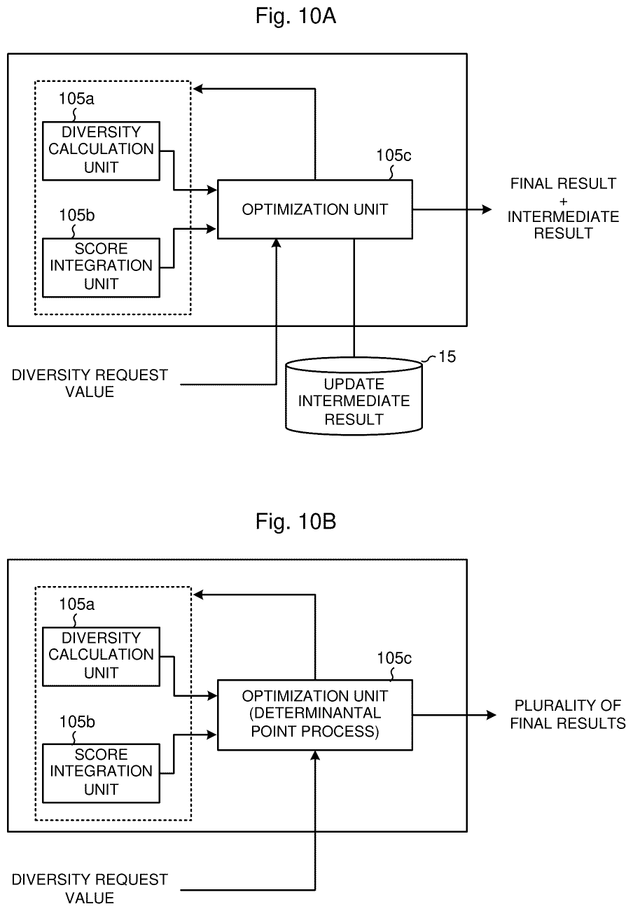

FIGS. 10A and 10B illustrate examples of processing for presenting a plurality of image retrieval results. FIG. 10A illustrates an example using an intermediate result. Referring to FIG. 10A, the optimization unit 105c stores an intermediate result of optimization processing and outputs the intermediate result in accordance with an instruction from the user. Specifically, the optimization unit 105c stores the value in the middle of update (intermediate result) of the correction value or adoption index of each image every time optimization processing is performed or at predetermined intervals. Then, the optimization unit 105c first presents images selected based on a final result, and then presents images selected based on the intermediate result in a case where an instruction for image switching is given by the user.

FIG. 10B illustrates an example using a determinantal point process as an optimization method. The optimization unit 105c can obtain a plurality of optimum solutions (namely, a plurality of final results) using a determinantal point process as an optimization method. Thus, the optimization unit 105c can present images selected based on each of the plurality of final results. Note that the optimization unit 105c may assign priorities to the plurality of optimum solutions, based on a previously determined criterion, and may perform image switching for presentation in descending order of priority.

As above, in a case where image retrieval is performed with a decrease in the diversity of the capturing location, the image retrieval device 10 can make a switch between a plurality of image retrieval results for display. Note that the above description has been given with the capturing location as an example, but other types of external information, such as the capturing time, can be applied.

### APPLICATION EXAMPLES

Next, application examples of the image retrieval device will be described.

### Application Example 1: Utilization During Disaster

The image retrieval device according to the present disclosure can be used in order to grasp the disaster situation at the time of disaster. For example, the image retrieval device retrieves images based on a user's intention from an enormous number of images each indicating a captured disaster site. Then, the image retrieval device presents, to the user, the retrieved images and a map indicating the capturing locations of the retrieved images. Examples of images of disaster sites include images of collapsed buildings and cut-off roads. Such images of disaster sites are captured by, for example, smartphones, driving recorders, and street cameras.

The user retrieves images of disaster sites with an increase in the diversity request value of the capturing location, so that the user can grasp the entire disaster situation. In addition, the user retrieves images of disaster sites with a decrease in the diversity request value of the capturing location, so that the user can grasp an area with a high density of damage and the disaster situation of the area. Thus, the user can assign priority to the area with a high density of damage for rescue activities, recovery activities, or evacuation guidance.

The user may specify a retrieval target area, in addition to the diversity request value of the capturing location. Examples of the retrieval target area include a predetermined city, town, or village and a predetermined zone in a city, town, or village. In response to input of the diversity request value of the capturing location and the retrieval target area, the image retrieval device performs image retrieval with an increase (or a decrease) in diversity in the retrieval target area. As above, the user can perform image retrieval with an increase (or a decrease) in diversity in a certain limited area and thus can acquire images based on the intention, more easily.

### Application Example 2: Road Management

The image retrieval device according to the present disclosure can be used in order to grasp road damage. For example, the image retrieval device retrieves images based on a user's intention from road damage images provided from local residents. Then, the image retrieval device presents, to the user, the retrieved images and a map indicating the capturing locations of the retrieved images. For example, the user retrieves road damage images with a decrease in the diversity of the capturing location, so that the user can grasp an area with a high density of road damage and the degree of damage in the area. Thus, the user can determine the order of priority for site inspection, such as a priority inspection to the area with a high density of road damage.

### Application Example 3: Travel

The image retrieval device according to the present disclosure can be used for sightseeing tours. For example, the image retrieval device retrieves images based on a user's intention from images of tourist attractions. Then, the image retrieval device presents, to the user, the retrieved images and a map indicating the capturing locations of the retrieved images. For example, the user retrieves images of desired architectural structures, such as “temples”, with a decrease in the diversity of the capturing location, so that the user can grasp an area with a high density of desired architectural structures and images of architectural structures in the area. Thus, the user can determine an area for sightseeing.

### Application Example 4: Investigation Support

The image retrieval device according to the present disclosure can be used for investigation support. For example, the image retrieval device retrieves images based on a user's intention from images captured by street security cameras. The images based on a user's intention each include an investigation target, such as a particular person or vehicle. For example, the user performs image retrieval for the investigation target with an increase in the diversity request value of the capturing time or capturing location, so that the user can grasp the appearance situation of the investigation target in various periods of time or locations. In addition, the user performs image retrieval for the investigation target with a decrease in the diversity request value of the capturing time or capturing location, so that the user can narrow the period of time or location of appearance of the investigation target.

The user may specify a retrieval target area, in addition to the diversity request value. In response to input of the diversity request value and the retrieval target area, the image retrieval device can perform image retrieval for the investigation target with an increase (or a decrease) in the diversity of the capturing time or capturing location in the retrieval target area. Note that the user may specify, for example, a retrieval target period of time, in addition to the retrieval target area. The image retrieval device can perform image retrieval with an increase (or a decrease) in the diversity of the capturing location in the retrieval target period of time. As above, the user can perform image retrieval with an increase (or a decrease) in diversity in a certain limited area or a certain limited period of time, so that the user can acquire images based on the intention, more easily.

### Second Example Embodiment

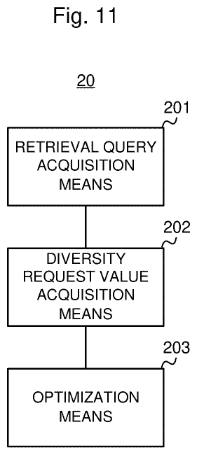

FIG. 11 is a block diagram illustrating a functional configuration of an image retrieval device according to a second example embodiment. An image retrieval device 20 includes a retrieval query acquisition means 201, a diversity request value acquisition means 202, and an optimization means 203.

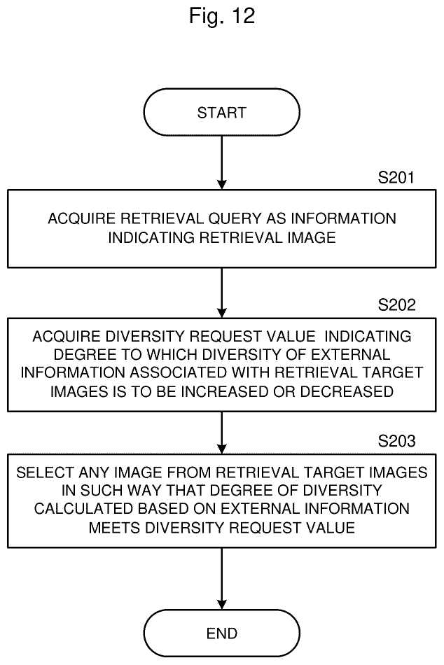

FIG. 12 is a flowchart of processing that the image retrieval device according to the second example embodiment performs. The retrieval query acquisition means 201 acquires a retrieval query as information indicating a retrieval image (step S201). The diversity request value acquisition means 202 acquires a diversity request value indicating degree to which diversity of external information associated with retrieval target images is to be increased or decreased (step S202). The optimization means 203 selects any image from the retrieval target images in such a way that the degree of diversity calculated based on the external information meets the diversity request value (step S203).

The retrieval query acquisition means 201 and the diversity request value acquisition means 202 can be achieved using the input information acquisition unit 101 according to the first example embodiment. The optimization means 203 can be achieved using the external information formatting unit 102, the feature extraction unit 103, the retrieval score calculation unit 104, and the diversity adjustment unit 105 according to the first example embodiment.

The image retrieval device according to the second example embodiment enables image retrieval with diversity controlled.

Some or all of the example embodiments described above may also be described as, but are not limited to, the following Supplementary Notes.

### Supplementary Note 1

An image retrieval device including:
a retrieval query acquisition means for acquiring a retrieval query as information indicating a retrieval image;
a diversity request value acquisition means for acquiring a diversity request value indicating degree to which diversity of external information associated with retrieval target images is to be increased or decreased; and
an optimization means for selecting an image from the retrieval target images in such a way that a degree of diversity calculated based on the external information meets the diversity request value.

### Supplementary Note 2

The image retrieval device according to Supplementary Note 1, further including a retrieval score calculation means for calculating a retrieval score of each of the retrieval target images, based on a feature of the retrieval query and a feature of each of the retrieval target images, in which
the optimization means optimizes an image retrieval result, based on the diversity request value, the retrieval score, and the degree of diversity calculated based on the external information.

### Supplementary Note 3

The image retrieval device according to Supplementary Note 2, in which the optimization means determines a combination of images to be output as the image retrieval result from the retrieval target images, with a level of the retrieval score and the increase or the decrease in the diversity of the external information taken into account using a predetermined optimization method.

### Supplementary Note 4

The image retrieval device according to Supplementary Note 3, in which the external information includes a capturing location and a capturing time.

### Supplementary Note 5

The image retrieval device according to Supplementary Note 4, in which the retrieval target images include images regarding disaster including images of disaster sites, and
the optimization means determines a combination of images of disaster sites diversified in terms of the capturing location or a combination of images of disaster sites localized in terms of the capturing location from the retrieval target images, with the level of the retrieval score and an increase or a decrease in diversity of the capturing location taken into account, and outputs the determined combination of images of disaster sites as the image retrieval result.

### Supplementary Note 6

The image retrieval device according to Supplementary Note 4, in which the retrieval target images include images captured by street security cameras,
the retrieval query includes information indicating an investigation target, and
the optimization means determines a combination of images of the investigation target diversified in terms of the external information or a combination of images of the investigation target localized in terms of the external information from the retrieval target images, with the level of the retrieval score and the increase or the decrease in the diversity of the external information taken into account, and outputs the determined combination of images of the investigation target as the image retrieval result.

### Supplementary Note 7

The image retrieval device according to Supplementary Note 3, in which the optimization means obtains an optimum solution of a correction score or an adoption index of each of the retrieval target images using the predetermined optimization method and determines the combination of images, based on the optimum solution, and
the correction score or the adoption index is an indicator indicating whether the associated retrieval target image is to be adopted as the image retrieval result.

### Supplementary Note 8

The image retrieval device according to Supplementary Note 7, in which the optimization means selects images from the retrieval target images, based on the correction score or the adoption index, and updates the correction score or the adoption index, based on an integrated score in which the retrieval scores of the selected images are integrated together, a degree of diversity calculated based on the external information on the selected images, and the diversity request value.

### Supplementary Note 9

The image retrieval device according to Supplementary Note 8, in which the external information includes a capturing location, and
the optimization means extracts combinations each involving two images from the selected images, calculates a distance between capturing locations of the two images for each of the combinations extracted, and determines the degree of diversity based on a calculation result.

### Supplementary Note 10

The image retrieval device according to Supplementary Note 9, in which the distance between capturing locations is a straight-line distance or a distance on a sphere.

### Supplementary Note 11

The image retrieval device according to Supplementary Note 9, in which the distance between capturing locations is a length of a road in travel between the capturing locations or a travel time in travel between the capturing locations.

### Supplementary Note 12

The image retrieval device according to Supplementary Note 9, in which the distance between capturing locations is a travel distance or a travel time in travel by public transportation, and
the optimization means assigns a weight to the degree of diversity, based on a type of public transportation or a transfer to another type of public transportation.

### Supplementary Note 13

The image retrieval device according to Supplementary Note 8, in which the external information includes a capturing location, and
the optimization means extracts combinations each involving a plurality of images from the selected images, calculates a minimum travel distance or a minimum travel time in visiting to capturing locations of the plurality of images for each of the combinations extracted, and determines the degree of diversity based on a calculation result.

### Supplementary Note 14

The image retrieval device according to Supplementary Note 8, in which the external information includes a capturing location, and
the optimization means takes a minimum travel distance or a minimum travel time in visiting to all capturing locations of the selected images as the degree of diversity.

### Supplementary Note 15

The image retrieval device according to Supplementary Note 8, in which the optimization means stores the correction score or the adoption index during optimization as an optimization intermediate result, determines a combination of images based on the optimization intermediate result in accordance with an instruction from a user, and outputs the combination of images.

### Supplementary Note 16

The image retrieval device according to Supplementary Note 8, in which the predetermined optimization method includes a determinantal point process, and
the optimization means determines, in a case where a plurality of optimum solutions is obtained, a combination of a plurality of images based on the plurality of optimum solutions, and outputs the combination of a plurality of images.

### Supplementary Note 17

The image retrieval device according to Supplementary Note 2, in which the retrieval score calculation means calculates similarity between the feature of the retrieval query and the feature of each of the retrieval target images, and sets a higher value to the retrieval score of a retrieval target image the similarity of which is higher in the retrieval target images.

### Supplementary Note 18

The image retrieval device according to Supplementary Note 4, in which the external information includes image appearance information.

### Supplementary Note 19

An image retrieval method to be performed by a computer, the image retrieval method including:
acquiring a retrieval query as information indicating a retrieval image;
acquiring a diversity request value indicating degree to which diversity of external information associated with retrieval target images is to be increased or decreased; and
selecting an image from the retrieval target images in such a way that a degree of diversity calculated based on the external information meets the diversity request value.

### Supplementary Note 20

A program for causing a computer to perform processing including:
acquiring a retrieval query as information indicating a retrieval image;
acquiring a diversity request value indicating degree to which diversity of external information associated with retrieval target images is to be increased or decreased; and
selecting an image from the retrieval target images in such a way that a degree of diversity calculated based on the external information meets the diversity request value.

While the present disclosure has been particularly shown and described with reference to example embodiments and examples thereof, the present disclosure is not limited to these example embodiments and examples. It will be understood by those of ordinary skill in the art that various changes in form and details may be made therein without departing from the spirit and scope of the present disclosure as defined by the claims.

### DESCRIPTION OF SYMBOLS

5 image database (DB)
10 image retrieval device
15 database (DB)
101 input information acquisition unit
102 external information formatting unit
103 feature extraction unit
104 retrieval score calculation unit
105 diversity adjustment unit
105a diversity calculation unit
105b score integration unit
105c optimization unit

1. An image retrieval device comprising:
at least one memory configured to store instructions; and
at least one processor configured to execute the instructions to:
acquire a retrieval query as information indicating a retrieval image;
acquire a diversity request value indicating degree to which diversity of external information associated with retrieval target images is to be increased or decreased; and
select an image from the retrieval target images in such a way that a degree of diversity calculated based on the external information meets the diversity request value.

2. The image retrieval device according to claim 1, the one or more processors are further configured to:
calculate a retrieval score of each of the retrieval target images, based on a feature of the retrieval query and a feature of each of the retrieval target images, wherein
wherein the one or more processors optimize an image retrieval result, based on the diversity request value, the retrieval score, and the degree of diversity calculated based on the external information.

3. The image retrieval device according to claim 2, wherein the one or more processors determine a combination of images to be output as the image retrieval result from the retrieval target images, with a level of the retrieval score and an increase or a decrease in the diversity of the external information taken into account using a predetermined optimization method.

4. The image retrieval device according to claim 3, wherein the external information includes a capturing location or a capturing time.

5. The image retrieval device according to claim 4, wherein the retrieval target images include images regarding disaster including images of disaster sites, and
the one or more processors determine a combination of images of disaster sites diversified in terms of the capturing location or a combination of images of disaster sites localized in terms of the capturing location from the retrieval target images, with the level of the retrieval score and an increase or a decrease in diversity of the capturing location taken into account, and output the determined combination of images of disaster sites as the image retrieval result.

6. The image retrieval device according to claim 4, wherein the retrieval target images include images captured by street security cameras,
the retrieval query includes information indicating an investigation target, and
the one or more processors determine a combination of images of the investigation target diversified in terms of the external information or a combination of images of the investigation target localized in terms of the external information from the retrieval target images, with the level of the retrieval score and the increase or the decrease in the diversity of the external information taken into account, and output the determined combination of images of the investigation target as the image retrieval result.

7. The image retrieval device according to claim 3, wherein the one or more processors obtain an optimum solution of a correction score or an adoption index of each of the retrieval target images using the predetermined optimization method and determine the combination of images, based on the optimum solution, and
the correction score or the adoption index is an indicator indicating whether the associated retrieval target image is to be adopted as the image retrieval result.

8. The image retrieval device according to claim 7, wherein the one or more processors select images from the retrieval target images, based on the correction score or the adoption index, and update the correction score or the adoption index, based on an integrated score in which the retrieval scores of the selected images are integrated together, a degree of diversity calculated based on the external information on the selected images, and the diversity request value.

9. The image retrieval device according to claim 8, in which the external information includes a capturing location, and
the one or more processors extract combinations each involving two images from the selected images, calculate a distance between capturing locations of the two images for each of the combinations extracted, and determine the degree of diversity based on a calculation result.

10. The image retrieval device according to claim 9, in which the distance between capturing locations is a straight-line distance or a distance on a sphere.

11. The image retrieval device according to claim 9, in which the distance between capturing locations is a length of a road in travel between the capturing locations or a travel time in travel between the capturing locations.

12. The image retrieval device according to claim 9, in which the distance between capturing locations is a travel distance or a travel time in travel by public transportation, and
the one or more processors assign a weight to the degree of diversity, based on a type of public transportation or a transfer to another type of public transportation.

13. The image retrieval device according to claim 8, in which the external information includes a capturing location, and
the one or more processors extract combinations each involving a plurality of images from the selected images, calculate a minimum travel distance or a minimum travel time in visiting to capturing locations of the plurality of images for each of the combinations extracted, and determine the degree of diversity based on a calculation result.

14. The image retrieval device according to claim 8, in which the external information includes a capturing location, and
the one or more processors take a minimum travel distance or a minimum travel time in visiting to all capturing locations of the selected images as the degree of diversity.

15. The image retrieval device according to claim 8, in which the one or more processors store the correction score or the adoption index during optimization as an optimization intermediate result, determine a combination of images based on the optimization intermediate result in accordance with an instruction from a user, and output the combination of images.

16. The image retrieval device according to claim 8, in which the predetermined optimization method includes a determinantal point process, and
the one or more processors determine, in a case where a plurality of optimum solutions is obtained, a combination of a plurality of images based on the plurality of optimum solutions, and output the combination of a plurality of images.

17. The image retrieval device according to claim 2, in which the one or more processors calculate similarity between the feature of the retrieval query and the feature of each of the retrieval target images, and set a higher value to the retrieval score of a retrieval target image the similarity of which is higher in the retrieval target images.

18. The image retrieval device according to claim 4, in which the external information includes image appearance information.

19. An image retrieval method to be performed by a computer, the image retrieval method comprising:
acquiring a retrieval query as information indicating a retrieval image;
acquiring a diversity request value indicating degree to which diversity of external information associated with retrieval target images is to be increased or decreased; and
selecting an image from the retrieval target images in such a way that a degree of diversity calculated based on the external information meets the diversity request value.

20. A program for causing a computer to perform processing comprising:
acquiring a retrieval query as information indicating a retrieval image;
acquiring a diversity request value indicating degree to which diversity of external information associated with retrieval target images is to be increased or decreased; and
selecting an image from the retrieval target images in such a way that a degree of diversity calculated based on the external information meets the diversity request value.
